(19) United States
(12) Patent Application Publication
(10) Pub. No.: US 2003/0180531 A1
(43) Pub. Date: Sep. 25, 2003

(54) PSA tape and its production

(75) Inventors: Marc Husemann, Hamburg (DE); Stephan Zollner, Hamburg (DE); Reinhard Storbeck, Hamburg (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(73) Assignee: tesa AG, Hamburg (DE)

(21) Appl. No.: 10/338,556

(22) Filed: Jan. 8, 2003

(30) Foreign Application Priority Data
Jul. 10, 2002 (DE) 102 31 065.3
Mar. 22, 2002 (DE) 102 12 830.8

(51) Int. Cl. B32B 7/12

(52) U.S. Cl. 428/354; 428/344; 428/345

(57) ABSTRACT

The invention relates to a pressure sensitive adhesive (PSA) tape and to a process for crosslinking PSA on backing materials which are more resistant to electron beams. The process is distinguished by a backing material which has been modified with one or more very thin layers of one or more conductive materials. During EB crosslinking the accelerated electrons penetrate the adhesive and the backing material and are dispersed over the entire backing material, or braked, at the electrically conductive layer. The damage to the backing which occurs at high EB doses is thereby minimized.

The invention relates to a pressure sensitive adhesive (PSA) tape comprising a backing and applied thereon a coating of a pressure sensitive adhesive, and also to a process for producing pressure sensitive adhesive tapes. The invention relates to the field of pressure sensitive adhesives crosslinked with electron beams (EB).

### BACKGROUND OF THE INVENTION

As a result of ever greater environmental impositions and pressure on costs, the trend at present is to produce pressure sensitive adhesives with only small amounts, if any, of solvent. This objective can easily be realized through the hotmelt technology. A further advantage of this technology is the shortening of production time. Hotmelt lines are able to laminate backings or release paper with adhesives at a significantly greater speed, thus saving time and money.

The hotmelt technology, however, is imposing ever more stringent requirements on the adhesives. For high-grade industrial applications polyacrylates are preferred in particular, on account of their transparency and weathering stability. In addition to these advantages, however, these acrylic PSAs must also meet exacting requirements in the area of shear strength. This is achieved by means of polyacrylates having high molecular weight and high polarity, with subsequent efficient crosslinking. Other elastomers as well that are used for PSA tape applications must be crosslinked in order to raise cohesion. Examples thereof are natural rubber adhesives, which are significantly more favorable than polyacrylates and are therefore used for adhesive packaging tapes. They too are crosslinked to raise the cohesion, in some cases using EB (electron beams). Generally speaking, PSAs can be crosslinked thermally, by UV or by EBC. The thermal crosslinking of hotmelts only proceeds via relatively complex crosslinking reactions, and frequently results in gelling prior to coating. UV and EBC crosslinking, on the other hand, are significantly more popular. The UV technology is relatively inexpensive in terms of apparatus; however, owing to the photoinitiators which can be used and the unfavorable absorption of light by some resin-blended PSAs, acrylic PSA tapes, for example, can be crosslinked efficiently at a maximum of 100 g/m². For natural rubber adhesives, UV crosslinking is even less favorable. Here, fillers, such as chalk, significantly lower the optical transparency of the material and hence also the maximum application rate which can be employed. Another limiting factor is set by the web speeds that are achievable. The EBC technology is significantly better suited to this purpose. Given a high accelerating voltage of the electrons, PSAs even at high application rate are completely penetrated and crosslinked.

Nevertheless, this technology is not without its disadvantages. In the conventional process setup, the PSA tape is irradiated with electrons on a steel roller. In order to achieve uniform crosslinking of the adhesive, it is necessary to radiate through the adhesive tape. During the continuous irradiation of bale product, electrons remain between the backing and the steel roller. On departing the backing material they cause damage to its reverse face. This is true particularly of siliconized release papers. In some cases, at high EB doses, eruptions are observable which destroy the silicone layer. The damage to the reverse face drastically increases the unwind forces of the PSA tape: where damage is very great, the PSA tapes are no longer unwindable and are therefore useless. Other backing materials are completely destroyed by the EBC, or suffer discoloration. Exactly the same problem exists for sensitive process liners, which lose their effect as a result of long-term EB irradiation.

It is an object of the invention to provide a process for producing PSA tapes, and to provide particular PSA tapes produced by said process, in which the damage to the backing as a result of EB curing (particularly on the reverse of the tapes) is minimized.

In accordance with the invention, a marked reduction in the damage to the reverse face of the backing materials can be achieved by modifying these materials.

### SUMMARY OF THE INVENTION

In a pressure sensitive adhesive tape of the type specified at the outset, this object is achieved by providing the backing with at least one layer of an electrically conducting material. Further advantageous embodiments are characterized in the subclaims.

### DETAILED DESCRIPTION

In the course of EB crosslinking the accelerated electrons penetrate the PSA and, where appropriate, the backing material or parts thereof and are dispersed over the entire backing material, or braked, at an electrically conductive layer. Owing to the presence of the electrically conductive layer, the damage to the backing which occurs as a result of irradiation is minimized.

For crosslinking, any EB-crosslinkable PSA can be used. The adhesives ought to possess pressure sensitive adhesion properties in accordance with D. Satas [Handbook of Pressure Sensitive Adhesive Technology, 1989, VAN NOSTRAND REINHOLD, New York]. For acrylic PSAs it is preferred to use polymers having the following composition:

(A) acrylic acid and methacrylic acid derivatives, with a fraction of 65-100 percent by weight,

CH₂═C(R₁)(COOR₂) (I)

where R₁=H or CH₃ and R₂=an alkyl chain having 2-20 carbon atoms,

(B) vinyl compounds containing functional groups, maleic anhydride, styrene, styrenic compounds, vinyl acetate, acrylamides, double bond functionalized photoinitiators etc.

with a fraction of 0-35 percent by weight.

For natural rubber adhesives, the natural rubber is ground to a freely selectable molecular weight, and provided with additives. EB-crosslinkable synthetic rubber adhesives can also be used.

In addition, crosslinkers and crosslinking promoters can be admixed. Suitable crosslinkers for electron beam crosslinking and UV crosslinking are, for example, difunctional or polyfunctional acrylates, difunctional or polyfunctional isocyanates (in both blocked and unblocked forms), and difunctional or polyfunctional epoxides.

For further development, resins can be admixed to the inventive PSAs. Tackifying resins for addition which can be used include, without exception, all tackifier resins which are known and described in the literature. Representatives that may be mentioned include the pinene resins, indene resins and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to set the properties of the resultant adhesive in accordance with what is desired. Generally speaking, all resins which are compatible (soluble) with the corresponding polyacrylate can be used; reference may be made in particular to all aliphatic, aromatic, and alkylaromatic hydrocarbon resins, hydrocarbon resins based on pure monomers, hydrogenated hydrocarbon resins, functional hydrocarbon resins, and natural resins. Specific reference is made to the depiction of the state of the art in the “Handbook of Pressure Sensitive Adhesive Technology” by Donatas Satas (van Nostrand, 1989).

Furthermore it is possible optionally to add plasticizers, further fillers (such as fibers, carbon black, zinc oxide; chalk, solid or hollow glass beads, microbeads made of other materials, silica, silicates, for example), nucleators, blowing agents, compounding agents and/or aging inhibitors, in the form for example of primary and secondary antioxidants or in the form of light stabilizers.

The pressure sensitive adhesives blended in this way are applied from solution or as a hotmelt to a backing provided with at least one layer of an electrically conducting material. The more EB-resistant backing possesses an electrically conducting layer either between backing material and adhesive side or between backing material and release material, or between both. For the latter case, the same or two different electrically conductive materials can be used.

Release materials which can be used are all those known to the skilled worker, such as silicone compounds, PE compounds and fluoro compounds, for example. A corresponding list can be found in D. Satas [Handbook of Pressure Sensitive Adhesive Technology, 1989, VAN NOSTRAND REINHOLD, New York]. Backing materials used are preferably paper (in any form), PVC, PET, BOPP, polyamides, polyimides, and further materials known to the skilled worker, but most preferably paper backings.

As electrically conductive materials it is possible to use any metals or metal alloys, or electrically conductive compounds, which are not destroyed or -damaged under EB irradiation. For coating, the electrically conductive material is preferably applied in thin layers to the backing material by vapor deposition. Metals may be, for example, aluminum, silver, copper, titanium, vanadium, etc. As electrically conductive materials it is also possible, however, to use any other compounds which possess electrical conductivity properties, including, for example, plastics, such as polyacrylonitrile, polyparavinylene (PPV), polyacetylene, compounds generally that are used as electrically conducting materials in the semiconductor industry, and compounds generally which can also be used as LED materials, such as polythiophenes, polyanthracene derivatives, polypyrrole, polyfluorenes, substituted PPVs, 3,4-polyethylenedioxythiophenes, polyaniline, etc. These electrically conductive materials are again applied to the backing by vapor deposition or applied in very thin layers from solution or as a hotmelt to the backing material.

The layer of the electrically conductive material should be very thin, preferably between 0.001 and 100 μm, so as to have as little effect as possible on the handling of the original backing material. For metals, an effect is achieved at thicknesses of more than 1 nm, although the preferred range lies between 0.1 and 10 μm. The electrically conductive material fulfils two functions: first, the conductivity disperses the incident electrons over the entire material; secondly, metals, for example, act as a brake to reduce the speed of the penetrating electrons, so that the energy of the electrons which reach the release material is significantly lower.

These PSA tapes, now modified by virtue of the electrically conducting layer, are cured with EB. At relatively high boundary layer doses, an improvement in reverse-face damage is achieved in a direct comparison between electrically conductive backing material and untreated backings. The minimum dose at which this effect appears is dependent on the particular PSA tape. Advantageous doses lie between 5 and 100 kGy, with an acceleration voltage of from 70 to 230 kV. As soon as EB-accelerated electrons reach and/or penetrate the release material, it is possible to exclude reverse-face damage as a result of the electrically conducting layer, or, with very high doses and accelerating voltages, to minimize such damage.

Typical irradiation equipment which may be employed comprises linear cathode systems, scanner systems and segmented cathode systems, where electron beam accelerators are concerned. A detailed description of the state of the art and the most important process parameters can be found in Skelhorne, Electron Beam Processing, in Chemistry and Technology of UV and EB formulation for Coatings, Inks and Paints, Vol. 1, 1991, SITA, London.

There is a direct correlation between reverse-face damage and the unwind characteristics of the PSA tape. Through elimination or reduction of the reverse-face damage, the unwind characteristics after EB crosslinking remain at the same level or improve as compared with the backing that has not been provided with an electrically conductive material.

In the process of the invention for producing a pressure sensitive adhesive tape comprising a backing and applied thereon a coating of a pressure sensitive adhesive, the backing is provided with at least one electrically conducting layer, the pressure sensitive adhesive is then coated onto the one electrically conducting layer or onto an external electrically conducting layer, and the pressure sensitive adhesive is cured by EB, as elucidated further in connection with the examples and the figures.

In accordance with one particular procedure, provision may also be made for the backing equipped with at least one electrically conducting layer to be passed in circulation as a process support, with the pressure sensitive adhesive following EB curing being removed from the underlying electrically conducting layer and laminated onto a further backing. In this case, the process support is damaged significantly less by electron beams than conventional process supports, owing to the inventive construction. In the further course of the process, the pressure sensitive adhesive is again removed from the process support. The process support ought to be composed of a particularly EB-resistant material, such as a polyamide, for example, or preferably a polyimide.

### BRIEF DESCRIPTION OF DRAWINGS

Individual embodiments of the invention are elucidated below with reference to drawings, in which:

FIG. 1 shows different modified backing materials:

Version 1: conductor between backing and PSA;

Version 2: conductor between backing and PSA and between backing and release layer;

Version 3: conductor between backing and release layer;

FIG. 2 shows the use of a backing equipped with an electrically conducting layer as a process support during the production of a PSA tape which is relaminated following EBC.

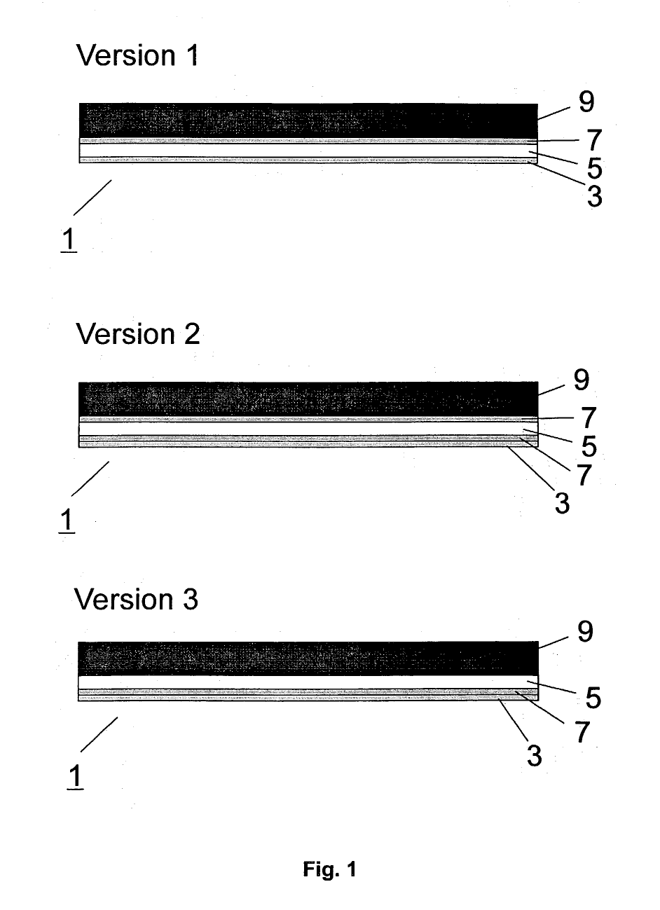

FIG. 1 shows three versions of a PSA tape which has been modified with at least one electrically conducting layer in order to reduce damage to the backing.

Version 1 is a diagram in cross section of the construction of a PSA tape 1, in which a backing 5 lined with a release layer 3 is equipped with an electrically conducting layer 7, on which in turn there is a coating 9 of a pressure sensitive adhesive. In the course of EB curing, electrons passing through the coating 9 of the PSA are braked, partially deflected, and dispersed at the electrically conducting layer 7. A large part of the radiation is kept away from the backing 5, thereby minimizing events that might damage the backing.

Version 2 is likewise a diagram in cross section of the construction of a PSA tape 1 in accordance with another exemplary embodiment, in which in addition to the electrically conducting layer 7 between PSA and backing there is a further electrically conducting layer 7 between backing 5 and release layer 3.

Version 3 shows in turn a diagram in cross section of the construction of a third exemplary embodiment of PSA tape 1, in which the electrically conducting layer 7 has been applied only between the backing 5 and the release layer 3. By this means, the silicone release papers in particular are protected.

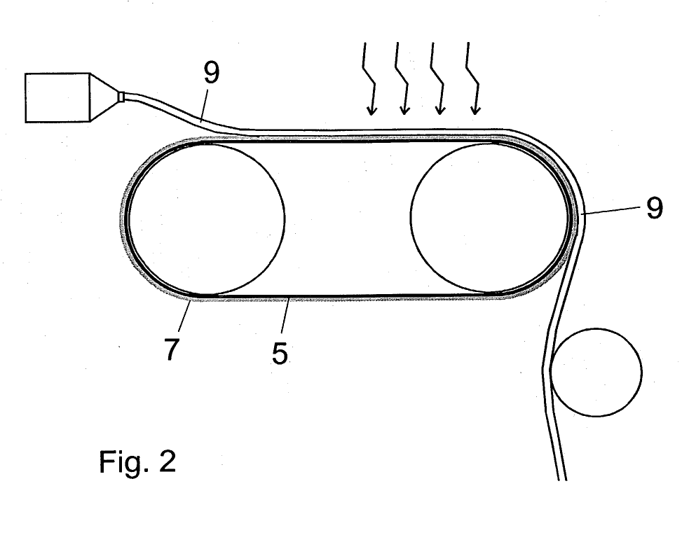

FIG. 2 diagrams the sequence during a production process for PSA tapes, in which a backing 5 is used as revolving process support. The circulated backing 5 is provided on its top face with an electrically conducting layer 7, to which a coating 9 of a hotmelt PSA is applied through a slot die. During transport on the process support, the PSA is then subjected to EB crosslinking, as indicated by the arrows. Here again, the electrically conducting layer 7 has a dispersing and braking effect and thereby reduces the damage to the process support 5. Following EB curing, the PSA coating 9 is removed from the process support, diverted and relaminated (not shown here) onto another backing.

The invention is elucidated in more detail below with the aid of test examples.

### EXAMPLE SECTION

The PSAs which can be used for this process have already been described in a preceding section. For irradiation, the PSA tape was conventionally irradiated with EB on a chill roll. As a reference, a release paper carrying 1.2 g/m² silicone was coated with an acrylic PSA.

The PSA tape was composed of a polyacrylate having the following monomer composition: 6% acrylic acid, 8% N-tert-butylacrylamide, 76% 2-ethylhexyl acrylate, and 10% methyl acrylate. The polymer had been prepared conventionally by free radical polymerization. The application rate on the backing material was 130 g/m². In the reference experiments, bale product was used and was initially irradiated on the open side of the release paper with different boundary layer doses.

For characterization, the unwind forces of the PSA tape were determined immediately after irradiation and after storage at 70° C. for 14 days.

The results are listed in table 1:

TABLE 1

| | | Unwind forces | |
|---|---|---|---|
| Exam- | Boundary layer | immediate | Unwind forces 14 days |
| ple | dose [kGy] | [cN/cm] | 70 ° C. [cN/cm] |
| 1 | 0 | 3 | 6 |
| 2 | 4 | 19 | 31 |
| 3 | 17 | 34 | 62 |

First of all, the unirradiated blank samples were measured (example 1). For this PSA tape, the unwind force was very low, at 3 cN/cm at room temperature and 6 cN/cm after 14 days of storage at 70° C. In the case of the EBC-irradiated specimens there was a sharp rise in the unwind forces. Even with a boundary layer dose of just 4 kGy (example 2) the unwind force was 19 cN/cm. Storage at 70° C. intensified this effect and after 14 days the unwind forces were 31 cN/cm. 4 kGy, however, is a dose which is significantly too low for efficient crosslinking of an acrylic PSA. A few more EB irradiations were also carried out with a boundary layer dose of 17 kGy (example 3). The EB irradiation causes visual damage to the release material. Eruptions are observed. This is reflected in the unwind forces measured. Following irradiation an unwind force of 34 cN/cm was measured, but increased to 62 cN/cm after storage at 70° C. It was virtually no longer possible to unwind the adhesive tape.

For the more EBC-resistant variant, the same paper backing was coated with aluminum by vapor deposition. The layer thickness of the aluminum conductor was approximately 1 μm. This material was then provided on the aluminized side with a 1.2 g application of silicone. This release paper was coated on the unsiliconized side with 130 g/m² polyacrylate. Except for the aluminum layer inserted, therefore, the product construction corresponded to that of the reference sample, and the construction is sketched in FIG. 1 as version 3. Again, bale product was used for EB irradiation.

The boundary layer doses selected for the Al-modified PSA tape were within the same range within the bounds of measurement error, so that the measurements are directly comparable with one another (table 2).

TABLE 2

| | | Unwind forces | |
|---|---|---|---|
| Exam- | Boundary layer | immediate | Unwind forces 14 days |
| ple | dose [kGy] | [cN/cm] | 70 ° C. [cN/cm] |
| 2' | 4 | 5 | 8 |
| 3' | 17 | 6 | 9 |

The unwind forces demonstrate that the aluminum layer in the backing exerts a positive effect on the damage to the release paper. Visually, eruptions could no longer be detected. The measured unwind forces also demonstrate that the release paper was damaged only to a relatively small extent by the EBC. Even with a boundary layer dose of 17 kGy (example 3′) and subsequent storage at 70° C. for 14 days, a maximum value of only 9 cN/cm was measured. These unwind forces are well within the range which is customary for PSA tapes.

The experiments are described in detail below.

Experiments

Test Methods

Measurement of the Unwind Forces

The unwind force was measured at a takeoff angle of 90° and a takeoff speed of 300 mm/min. The tensile force in cN/cm was determined using a tensile testing machine under standardized conditions (23° C., 50% air humidity). The measurements were carried out with rollers of constant width. For the measurement, the first 2-3 cm of the unwound PSA tape were discarded. The results correspond to the average of three measurements.

Production of the Samples

Preparation of the Polyacrylate and Production of the PSA Tape

A 200 L reactor conventional for free radical polymerizations was charged with 2 400 g of acrylic acid, 3 200 g of N-tert-butylacrylamide, 4 000 g of methyl acrylate, 30.4 kg of 2-ethylhexyl acrylate, and 30 kg of acetone/isopropanol (97:3). After nitrogen gas had been passed through it for 45 minutes, with stirring, the reactor was heated to 58° C. and 20 g of azoisobutyronitrile (AIBN) were added. The external heating bath was then warmed to 75° C. and the reaction was carried out constantly with this external temperature. After a reaction time of 1 hour a further 20 g of AIBN were added. After a reaction time of 48 hours the reaction was terminated and the mixture cooled to room temperature. The adhesive was then freed from solvent in a concentrating extruder and coated as a hotmelt, through a die, onto a glassine release paper from Laufenberg with a 1.2 g/m² application of silicone. For analysis, the unwind forces were determined in accordance with the test method.

Production of the Al-modified Backing Material

The same paper used by Laufenberg to produce release papers (in analogy to the reference) is coated with aluminum in a layer thickness of 1 μm by vapor deposition. The identical silicone material is then coated onto this aluminum layer at 1.2 g/m². This Al-modified backing is then coated with the identical PSA, in analogy to the reference, and is used as bale product.

Electron Irradiation

Electron irradiation was carried out using an instrument from Electron Crosslinking AB, Halmstad, Sweden. The PSA tape for irradiation was passed over a thermal conditioning roller (which is present as standard) beneath the Lenard window of the accelerator. In the zone of irradiation, the atmospheric oxygen was displaced by flushing with pure nitrogen. The web speed was 10 m/min in each case. The accelerator voltage was 230 kV. The boundary layer dose was set in each case at 4 and 17 kGy, the dose being checked using EBC dose sheets.

### Example 2

Irradiation was carried out using a conventional steel chill roll. The bale product (300 m) of the PSA tape was irradiated with a 4 kGy EBC boundary layer dose. The web speed was 10 m/min. For analysis, the unwind forces were determined in accordance with the test method.

### Example 3

Irradiation was carried out using a conventional steel chill roll. The bale product (300 m) of the PSA tape was irradiated with a 17 kGy EBC boundary layer dose. The web speed was 10 m/min. For analysis, the unwind forces were determined in accordance with the test method.

### Example 2′

The procedure of example 2 was repeated, with the PSA tape for crosslinking being composed of the polyacrylate and the aluminum-coated backing.

### Example 3′

The procedure of example 3 was repeated, with the PSA tape for crosslinking being composed of the polyacrylate and the aluminum-coated backing.

We claim:

1. A pressure sensitive adhesive tape comprising a backing coated with a pressure-sensitive adhesive, wherein the backing is provided with at least one layer of an electrically conductive material.

2. The tape as claimed in claim 1, wherein said pressure-sensitive adhesive comprises natural rubbers, synthetic rubbers or polyacrylates, optionally in compounded form.

3. The tape as claimed in claim 1, wherein said at least one layer of electrically conductive material comprises an electrically conductive metal.

4. The tape as claimed in claim 1, wherein said electrically conductive material is an electrically conductive plastic.

5. The tape as claimed in claim 1, wherein the adhesive is an electron beam (EB)-cured adhesive.

6. The tape as claimed in claim 5, wherein the adhesive is an adhesive cured with an electron beam acceleration voltage of 70-230 kV, and an applied dose of between 5 and 100 kGy.

7. A process for producing a pressure sensitive adhesive tape comprising a backing coated with a pressure-sensitive adhesive, wherein at least one electrically conductive layer is applied to the backing, the pressure sensitive adhesive is coated onto the at least one electrically conductive layer or onto a separate electrically conductive layer which is then applied to the backing, and the adhesive is cured by electron beam EB.

8. The process as claimed in claim 7, wherein the EB curing of the adhesive is conducted with an acceleration voltage of from 70 to 230 kV.

9. The process as claimed in claim 7, wherein the EB curing of the adhesive is conducted with a dose of between 5 and 100 kGy.

10. The process as claimed in claim 8, wherein the EB curing of the adhesive is conducted with a dose of between 5 and 100 kGy.

11. The process as claimed claim 7 wherein at least one electrically conductive layer is applied to the backing and said at least one electrically conductive layer is a metal layer and is applied to the backing by vapor deposition.

12. The process as claimed in claim 7, wherein at least one electrically conductive layer is applied to the backing and said at least one electrically conductive layer is a metal powder layer and is applied with a binder to the backing by spraying.

13. The process as claimed in claim 7, wherein at least one electrically conductive layer is applied to the backing and said at least one electrically conductive layer applied to the backing is an electrically conductive plastics layer.

14. The process as claimed in claim 13, wherein electrical conductivity of said plastic layer is achieved by addition of electrically conductive materials or doping.

15. A process for producing a pressure-sensitive adhesive tape, wherein an adhesive is applied to a support having at least one electrically-conductive layer, subjected to electron beam curing while on that support, then removed from the support and applied to a backing material.

16. The process as claimed in claim 15, wherein the support is composed of a substantially EB-resistant material.

17. The process of claim 16, wherein said substantially EB-resistant material is a polyimide material.
